(19) United States
(12) Patent Application Publication
(10) Pub. No.: US 2026/0246843 A1
(43) Pub. Date: Aug. 20, 2026

(54) METHOD OF HANDLING CONTROL, AND DEVICE, SYSTEM, AND STORAGE MEDIUM

(71) Applicant: CLOUD INTELLIGENCE ASSETS HOLDING (SINGAPORE) PRIVATE LIMITED, Singapore (SG)

(72) Inventors: Chenyang ZHU, Shanghai (CN); Zhi LING, Hangzhou, Zhejiang (CN); Fei YU, Shanghai (CN); Lei XU, Shenzhen, Guangdong (CN); Xiang HU, Hangzhou, Zhejiang (CN); Yueqian ZHANG, Shanghai (CN); Xiaolu CHU, Hangzhou, Zhejiang (CN); Miao ZHU, Hangzhou, Zhejiang (CN)

(73) Assignee: CLOUD INTELLIGENCE ASSETS HOLDING (SINGAPORE) PRIVATE LIMITED, Singapore (SG)

(21) Appl. No.: 19/161,707

(22) PCT Filed: Jan. 10, 2024
(86) PCT No.: PCT/CN2024/071537

§ 371 Date: Sep. 2, 2025

(30) Foreign Application Priority Data
Mar. 3, 2023 (CN) 202310230703.2

(51) Int. Cl. H04L 67/125

(52) U.S. Cl. CPC H04L 67/125

(57) ABSTRACT

A method of handling a control, a device, a system and a storage medium are provided. A server of a cloud-side application determines, from controls associated with the cloud-side application, a target control to be displayed on the client, and acquires pre-configured UI configuration information of the target control; and then, on the basis of the UI configuration information, the client is controlled to create the target control in a local window.

### CROSS REFERENCE TO RELATED APPLICATIONS

This disclosure is a National Stage of International Application PCT/CN2024/071537, filed on Jan. 10, 2024, which claims priority to Chinese Patent Application No. 202310230703.2, filed with the China National Intellectual Property Administration on Mar. 3, 2023 and entitled “CONTROL PROCESSING METHOD, AND DEVICE, SYSTEM, AND STORAGE MEDIUM”, the mentioned applications are incorporated herein by reference.

### TECHNICAL FIELD

This disclosure relates to the field of cloud computing technologies, and in particular, to a method of handling a control, a device, a system, and a storage medium.

### BACKGROUND

As cloud computing becomes increasingly mature, configuring a program module originally located in a terminal device at a server end to achieve slimming of the terminal device is a mainstream trend at present. Based on this, products such as a cloud desktop and a cloud application emerge.

In a related cloud desktop or cloud application, the cloud application or an application running in the cloud desktop runs in a cloud environment, and an application screen of the cloud-side application in the cloud environment is transmitted to a client by using a streaming protocol. The cloud application and the application running in the cloud desktop are collectively referred to as cloud-side applications. The client displays the application screen and controls on the screen based on received streaming data. The screen and the controls displayed by the client are a projection of a screen in the cloud environment.

In the related cloud desktop or cloud application, the screen and the controls displayed by the client are the projection of the screen in the cloud environment. Because the screen and the controls are controlled on the server end side, when a user performs an operation on the control, the server end needs to control the control. Consequently, a path from the cloud-side application to the user is long.

### SUMMARY

In view of the foregoing technical problem existing in a related cloud-side application, a plurality of aspects of this disclosure provide a method of handling a control, a device, a system, and a storage medium, to implement that the cloud-side application controls a client to create a control locally on the client, thereby helping shorten a path from the cloud-side application to a user.

An embodiment of this disclosure provides a method of handling a control, applicable to a server end of a cloud-side application, where the method includes: determining, from controls associated with the cloud-side application, a target control to be displayed on a client of the cloud-side application; obtaining preconfigured user interface (UI) configuration information of the target control; and controlling, based on the UI configuration information, the client to create the target control in a first window.

An embodiment of this disclosure further provides a method of handling a control, applicable to a client of a cloud-side application, where the method includes: receiving a control creation instruction sent by a server end of the cloud-side application; obtaining, from the control creation instruction, user interface (UI) configuration information of a target control associated with the cloud-side application; and creating the target control in a first window based on the UI configuration information.

An embodiment of this disclosure further provides a data processing system, including: a client of a cloud-side application, and a server end of the cloud-side application, where the client is configured to perform the steps in the method of handling the control applicable to the client of the cloud-side application; and the server end is configured to perform the steps in the method of handling the control applicable to the server end of the cloud-side application.

An embodiment of this disclosure further provides a computing device, including: a memory, a processor, and a communication component, where the memory is configured to store computer programs; and the processor is coupled to the memory and the communication component, and configured to execute the computer programs to perform the steps in the method performed by the client of the cloud-side application, and/or the steps in the method performed by the server end of the cloud-side application.

An embodiment of this disclosure further provides a computer-readable storage medium storing computer instructions, where when the computer instructions are executed by one or more processors, the one or more processors are caused to perform the steps in the method performed by the client of the cloud-side application, and/or the steps in the method performed by the server end of the cloud-side application.

It should be noted that, the foregoing summary is merely for the purpose of the specification, and is not intended to be limitative in any manner. In addition to the foregoing exemplary aspects, implementations, and characteristics, the aspects, implementations, and characteristics of this disclosure can be easily understood by referring to the accompanying drawings and the following detailed descriptions.

### BRIEF DESCRIPTION OF THE DRAWINGS

The accompanying drawings described herein are used to provide a further understanding of this disclosure, and form part of this disclosure. Exemplary embodiments of this disclosure and descriptions thereof are used to explain this disclosure, and do not constitute any inappropriate limitation to this disclosure.

FIG. 1 is a schematic flowchart of interaction of a cloud desktop system or a cloud application system according to a related solution.

FIG. 2 is a schematic flowchart of interaction of a data processing system according to an embodiment of this disclosure.

FIG. 3 is a schematic diagram of a display effect of a control according to an embodiment of this disclosure.

FIG. 4 is a schematic flowchart of control processing performed by a data processing system according to an embodiment of this disclosure.

FIG. 5 is a schematic diagram of a display effect of another control according to an embodiment of this disclosure.

FIG. 6 and FIG. 7 are schematic flowcharts of methods of handling a control according to embodiments of this disclosure.

FIG. 8 is a schematic diagram of a structure of a computing device according to an embodiment of this disclosure.

### DETAILED DESCRIPTION

To clearly states the objectives, technical solutions, and advantages of this disclosure, the technical solutions of this disclosure are clearly and completely described below with reference to the specific embodiments and the corresponding accompanying drawings of this disclosure. Clearly, the described embodiments are only some embodiments rather than all embodiments of this disclosure. All other embodiments obtained by a person of ordinary skill in the art based on embodiments of this disclosure without creative efforts shall fall within the protection scope of this disclosure.

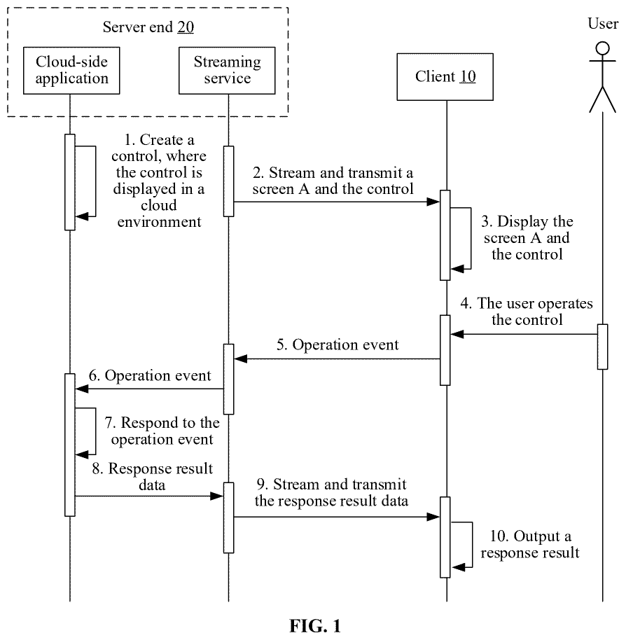

FIG. 1 is a schematic flowchart of interaction of a data processing system according to a related solution. The data processing system may be a cloud desktop system or a cloud application system. As shown in FIG. 1, the data processing system may include: a client 10 of a cloud-side application, and a server end 20 of the cloud-side application.

In this embodiment, the cloud-side application refers to an application deployed in a cloud environment, and may be a cloud application (Cloud Application), or may be an application running in a cloud desktop. The cloud application is an implementation of a cloud computing technology at an application layer. A working principle of the cloud application is to transform a use manner of “local installation and local computation” of a related software into an “on-demand” service. The client does not need to install corresponding software, and may connect to and operate a remote service cluster through the Internet or a local area network, to complete a business logic or a computational task.

Based on implementation of a virtualization technology on computer hardware resources, the computer hardware resources are virtualized into a plurality of virtual computers. The cloud desktop is a desktop operating system that may directly run on the virtual computers without any change. In addition, the cloud desktop further provides an operating system supporting a paravirtualization technology, and virtualized applications may directly run on the desktop operating system. The applications running in the cloud desktop refer to applications running in the desktop operating system. The application running in the cloud desktop may be an application having a user interface (User Interface, UI), such as an instant messaging application, an online shopping application, a social application, or an email application. Certainly, the application running in the cloud desktop may alternatively be an application without the UI, such as a background script and a system service running in the cloud desktop.

In this embodiment of this disclosure, the client 10 refers to an electronic device that is used by a user and that has a communication function and the like, and may be, for example, a mobile phone, a tablet computer, a personal computer, a wearable device, or an Internet of Things (Internet of Things, IoT) device. Certainly, the client 10 may alternatively be a thin client (Thin Client) such as a set top box. The client 10 usually includes at least one processing unit and at least one memory. The client 10 may also include basic configurations such as a network adapter chip, an IO bus, an audio/video component, and a display component. In an example, according to an implementation form of the client 10, some peripheral devices such as a keyboard, a mouse, an input pen, and a printer may also be included. Usually, the client 10 includes a display component.

In this embodiment of this disclosure, the server end 20 is a computer device that can provide a cloud-side application service, and usually has capabilities of providing a service and maintaining the service. The server end 20 may respond to a service request of the client 10, and provide the user with a service related to the cloud-side application. The server end 20 may be a single server device, a cloud-based server array, or a virtual machine (Virtual Machine, VM) running in the cloud-based server array. In addition, the server end 20 may also refer to another computing device having corresponding service capabilities, for example, a terminal device (running a service program) such as a computer.

The client 10 and the server end 20 may be in wireless or wired connection. In an example, the client 10 may be in communication connection with the server end 20 through a mobile network. A network standard of the mobile network may be any one of 2G (such as a global system for mobile communications (Global System for Mobile Communications, GSM)), 2.5G (such as a general packet radio service (General Packet Radio Service, GPRS)), 3G (such as wideband code division multiple access (Wideband Code Division Multiple Access, WCDMA), time division-synchronous code division multiple access (Time Division-Synchronous Code Division Multiple Access, TD-SCDMA), code division multiple access 2000 (Code Division Multiple Access 2000, CDMA2000), or a universal mobile telecommunications system (Universal Mobile Telecommunications System, UMTS)), 4G (such as long term evolution (Long Term Evolution, LTE)), 4G+ (such as LTE-advanced (LTE-Advanced, LTE-A)), 5G, world interoperability for microwave access (World Interoperability for Microwave Access, WiMax), or the like. In an example, the client 10 may alternatively be in communication connection with the server end 20 via Bluetooth, wireless fidelity (Wireless Fidelity, Wi-Fi), infrared, or the like.

As shown in FIG. 1, for the cloud desktop system, an application of the cloud desktop and other applications running in the cloud desktop are deployed on the server end 20. There may be one or a plurality of applications running in the cloud desktop. The plurality of applications means two applications or more than two applications. The plurality of applications may be deployed on a same physical machine, or may be deployed on different physical machines. For the cloud application system, applications of the cloud application are deployed on the server end 20. There may be one or more applications of the cloud application. In this embodiment of this disclosure, an implementation form of the cloud application is not limited. In an example, the cloud application may be a web page, client software, an application (Application, APP), a mini program, or the like.

In the related solution, regardless of the applications running in the cloud desktop or the cloud application, the user may request the cloud-side application service through the client 10 during use. In an example, the client 10 may initiate a start request to the server end 20 in response to a start operation of the user for the cloud-side application, where the start request is used for requesting to start the cloud-side application.

The server end 20 may start the cloud-side application in response to the start request; locally render a screen of the cloud-side application; and then send the screen of the cloud-side application to the client 10 by using a streaming media technology. The client 10 displays the screen of the cloud-side application based on obtained streaming media data.

During actual application, the screen of the cloud-side application is associated with a control. The control refers to a user interface (User Interface, UI) control, and the user may perform human-machine interaction with the client through the control. For example, the control may be a button control, a text box control, a file upload control, or the like.

In the related solution, for any screen A, the cloud-side application of the server end 20 may display the screen A on the server end 20, and determine a control associated with the screen A. Then, the control associated with the screen A may be created on the server end 20 according to control configuration information of the control associated with the screen A (step 1: “Create a control, where the control is displayed in a cloud environment” in FIG. 1). In this way, the screen A and the control associated with the screen A may be displayed in a cloud environment of the server end 20. The target control is a physical control with a specific UI layout. In an example, the cloud-side application of the server end 20 displays the screen A and creates the control in the cloud environment, so that the screen and the control are displayed in the cloud environment.

When the control associated with the screen A needs to be transmitted to the client 10, the server end 20 may send the screen A and the target control of the screen A to the client 10 by using the streaming media technology (step 2: “Stream and transmit the screen A and the control” in FIG. 1). The server end 20 provides a streaming service, where the service streams and transmits the screen A and the target control to the client 10 by using the streaming media technology.

In an implementation, the streaming service in the server end 20 may compress the screen A and the target control of the screen A by using a data compression technology, and send, to the client 10 by using the streaming media technology, a screen and a target control that are obtained through the data compression.

The client 10 may locally display the screen A and the target control of the screen A (step 3: “Display the screen A and the control” in FIG. 1). The screen A and the target control are actually drawn on the server end 20. The screen A and the target control that are displayed by the client 10 are projections of the screen and the control that are displayed by the server end 20. Usually, the client 10 receives streaming data obtained by compressing the screen and the target control. Therefore, resolutions of the screen and the control that are displayed on the client 10 are low.

In another aspect, because the screen and the control are controlled on the server end, when the user zooms in or zooms out the screen, the projection of the control on the client may be moved out of a display window of the client 10. Consequently, the user cannot operate the target control, and user experience is poor.

To resolve the technical problem existing in the foregoing related solution, in some embodiments of this disclosure, a server end of a cloud-side application may determine, from controls associated with the cloud-side application, a target control to be displayed on a client; obtain preconfigured UI configuration information of the target control; and then control, based on the UI configuration information, the client to create the target control in a local window. In this way, the cloud-side application controls the client to create the control locally on the client, and the cloud-side application can directly interact with the client, thereby helping shorten a path from the cloud-side application to a user.

Because the control is directly drawn on the client locally instead of being a projection in a cloud environment, this helps improve a resolution and definition of the control displayed on the client.

Because the control is drawn on the client locally, and that the user operates the control is to directly operate the control locally on the client, a link for triggering the user by the cloud-side application may be shortened, thereby helping reduce a delay of responding to a subsequent control operation.

The following describes the technical solutions provided in embodiments of this disclosure in detail with reference to the accompanying drawings.

It should be noted that, a same reference numeral represents a same object in the following accompanying drawings and embodiments. Therefore, once an object is defined in one accompanying drawing or embodiment, the object does not need to be further discussed in subsequent accompanying drawings and embodiments.

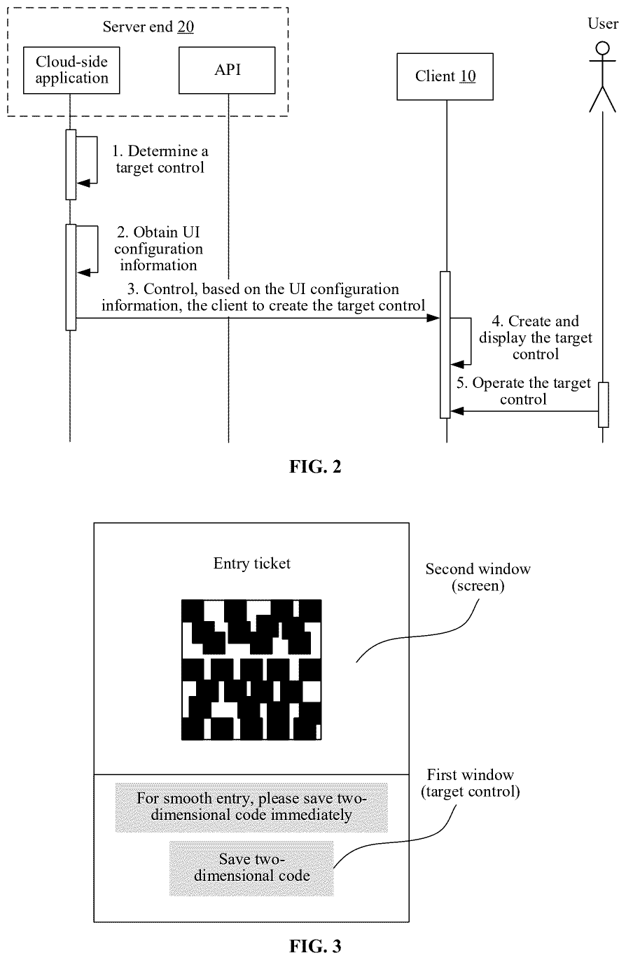

FIG. 2 is a schematic flowchart of interaction of a cloud-side application system according to an embodiment of this disclosure. For implementation forms of the client 10 and the server end 20, refer to related content in FIG. 1. Details are not described herein again.

In this embodiment, to implement that a screen of a cloud-side application is decoupled from a control, in some embodiments, a developer of the cloud-side application may configure associated controls for the cloud-side application at a development stage of the cloud-side application. The configured associated controls for the cloud-side application may be operation controls for the cloud-side application, such as a start control, an exit control, or a stop control of the cloud-side application. The start control is configured to start the cloud-side application. The exit control is configured to exit from the cloud-side application. The stop control is configured to stop running of the cloud-side application.

Certainly, the control associated with the cloud-side application may alternatively be a control configured for the screen of the cloud-side application, that is, a control associated with the screen. For example, a screen in FIG. 3 is a two-dimensional code screen. A control associated with the screen is “save the two-dimensional code”, and the control is configured to guide the user to save content “two-dimensional code” in the screen.

For one control, the control has UI-associated information, such as a style, a display location, and content of the control. The style of the control may include: an icon, a shape, a color, a size, and the like of the control. In some embodiments, at the development stage of the cloud-side application, the developer of the cloud-side application may write, into the cloud-side application, the control associated with the cloud-side application and the UI configuration information of the control. The UI configuration information refers to information for describing a UI layout of the control, and may include: a style, a display location, display content, and the like of the control.

The cloud-side application may store an identifier of the control and the UI configuration information of the control. In this way, when the server end 20 runs the cloud-side application, the server end 20 may obtain the identifier of the control and the UI configuration information of the control.

Because the control is configured to perform human-machine interaction with the user of the cloud-side application, when the user triggers the control, a response operation associated with the control is triggered. The developer of the cloud-side application may further configure response behavior data for the control. The response behavior data for the control is used for describing the response operation performed when the control is triggered. For example, a response operation corresponding to the control “save the two-dimensional code” in FIG. 3 is to trigger the “save the two-dimensional code” control, and save the two-dimensional code in the screen. For another example, a response operation corresponding to the “start control” corresponding to the cloud-side application is to trigger the start control, and start the cloud-side application, and the like.

Based on this, the developer of the cloud-side application may further write, into the cloud-side application, the identifier of the control configured for the cloud-side application and the response behavior data for the control. When the server end 20 runs the cloud-side application, the identifier of the control and the response behavior data for the control may be obtained from the cloud-side application.

For an embodiment of configuring a control for a page or a screen of the cloud-side application, the developer of the cloud-side application may configure the control for the cloud-side application, configure UI configuration information of the control and response behavior data for the control, and write an identifier of a target page, an identifier of the control configured for the page, the UI configuration information of the control, and the response behavior data for the control into the cloud-side application, and so on. When running the cloud-side application, the server end 20 may obtain the identifier of the target page, the identifier of the control of the target page, the UI configuration information of the control, the response behavior data for the control, and the like from the cloud-side application.

The developer of the cloud-side application shifts from being originally unaware of application cloudification and capable of only using a capability of an operating system in a cloud environment to being aware of the application cloudification and capable of not only using the capability of the cloud environment, but also using a capability of a local system of a user, thereby implementing optimization of interaction experience, and offering the application more freedom. A cloudification-oriented application or desktop may not only use computing power of a cloud-side system, but also adapt to a layout of a client-side system.

Based on the control and the UI configuration information of the control that are preconfigured in the foregoing embodiments, an embodiment of this disclosure provides a solution of drawing a control on a client of a cloud-side application in a cloud-side application scenario. Exemplary descriptions are provided below with reference to FIG. 2.

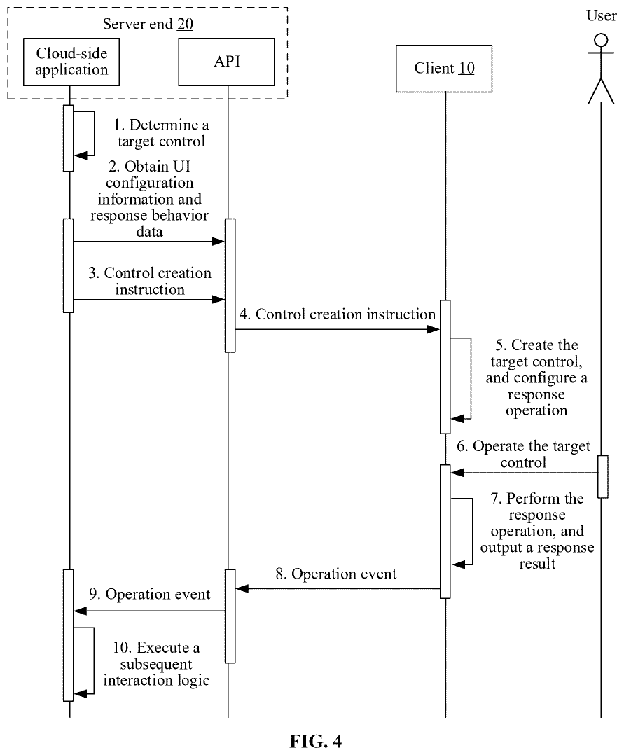

As shown in FIG. 2 and FIG. 4, a cloud-side application runs on a server end 20. The server end 20 may determine, from controls associated with the cloud-side application, a target control to be displayed on a client 10 of the cloud-side application (corresponding to step 1 in FIG. 2 and step 1 in FIG. 4). In an example, the cloud-side application on the server end 20 may determine, from the controls associated with the cloud-side application, the target control to be displayed on the client 10 of the cloud-side application.

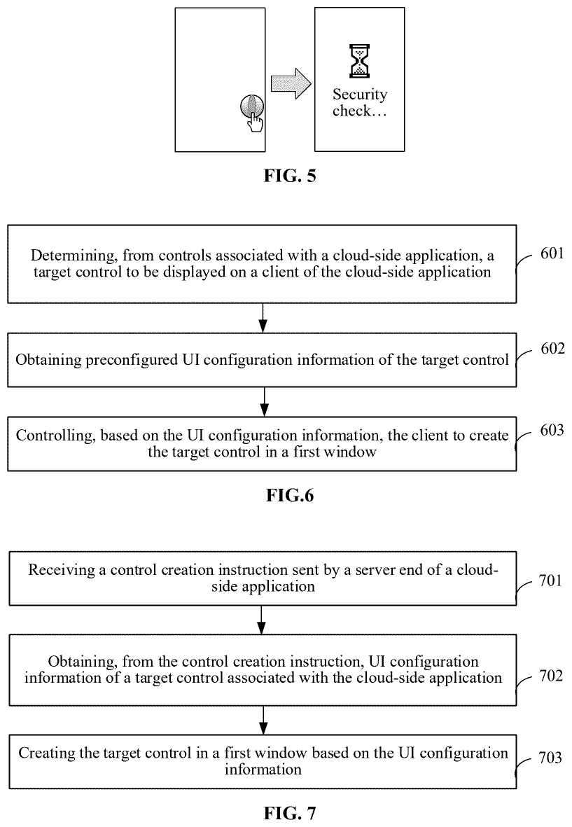

In some embodiments, the target control is a control, such as a start control, an exit control, or a stop control, configured to perform an operation on the cloud-side application. The cloud-side application on the server end 20 may determine, according to an identifier of the cloud-side application from the controls associated with the cloud-side application, a control configured to represent an operation on the cloud-side application as the target control. For example, in FIG. 5, a “ball” control represents a control of a start operation for anti-virus software. If the control is triggered, the anti-virus software may be started, to perform security check on the client 10.

In some other embodiments, the target control may be a control associated with a screen of the cloud-side application, such as a control configured to perform an operation on the screen of the cloud-side application, or a control configured to perform operation guidance on the screen of the cloud-side application, for example, the “save two-dimensional code” control of saving content “two-dimensional code” in the screen in FIG. 3. In this embodiment, a cloud application on the server end 20 may determine a to-be-transmitted screen according to a running process of the cloud-side application of the server end 20. The to-be-transmitted screen refers to a screen to be transmitted to the client 10, and is usually a screen to be displayed on the cloud-side application. In an example, a control associated with the to-be-transmitted screen may be determined as the target control according to an identifier of the to-be-transmitted screen from the controls associated with the cloud-side application.

In an implementation, a preconfigured control configured to perform operation guidance on the to-be-transmitted screen may be determined as the target control according to the identifier of the to-be-transmitted screen from the controls associated with the cloud-side application.

After determining the target control, the server end 20 may obtain preconfigured UI configuration information of the target control. In an example, the cloud-side application on the server end 20 may obtain the preconfigured UI configuration information of the target control. For a process of configuring the UI information for the control, refer to related content in the foregoing embodiments. Details are not described herein again.

In an implementation, the server end 20 may obtain the UI configuration information of the target control (corresponding to step 2 in FIG. 2). In an example, the cloud-side application on the server end 20 may obtain, according to the running process of the cloud-side application, the control corresponding to the running process as the target control, and obtain the UI configuration information of the target control.

In an implementation, the server end 20 may control, based on the UI configuration information, the client 10 to create the target control in a display window (defined as a first window) (corresponding to step 3 and step 4 in FIG. 2). The target control created by the client 10 is a physical UI control. The client 10 may display the target control.

In this embodiment, to enable the server end 20 to control the client 10 to draw the control, an application programming interface (Application Programming Interface, API) related to control processing may be added in the server end 20, where the API is an interface for controlling the client 10. In this embodiment, the API may be an API in a guest operating system (Guest Operating System, Guest OS) in the cloud environment. The Guest OS may be an operating system installed on a virtual machine of the server end 20.

Based on the foregoing API, the cloud-side application on the server end 20 may invoke the foregoing API to control the client 10 to create the display window, so that the cloud-side application directly interacts with the client, thereby helping shorten a path from the cloud-side application to the user.

In an implementation, the server end 20 may encapsulate the UI configuration information of the target control into a control creation instruction according to a network transmission protocol. The network transmission protocol may be a transmission control protocol (Transmission Control Protocol, TCP), a hypertext transfer protocol (Hypertext Transfer Protocol, HTTP), or the like. In an example, the server end 20 may send the control creation instruction to the client 10.

In an implementation, as shown in step 3 and step 4 of FIG. 4, the cloud-side application on the server end 20 may invoke the API in the foregoing embodiment, to encapsulate the UI configuration information of the target control into the control creation instruction according to the network transmission protocol; and send the control creation instruction to the client 10 through the API.

The client 10 may receive the control creation instruction, and obtain the UI configuration information of the target control from the control creation instruction. In an example, the client 10 may create the target control in the local first window based on the UI configuration information (step 5 in FIG. 4).

In this embodiment, the server end of the cloud-side application may determine, from the controls associated with the cloud-side application, the target control to be displayed on the client; obtain the preconfigured UI configuration information of the target control; and then control, based on the UI configuration information, the client to create the target control in the local window. In this way, the cloud-side application controls the client to create the control locally on the client, and the cloud-side application can directly interact with the client, thereby helping shorten the path from the cloud-side application to the user. Because the control is directly drawn on the client locally instead of being a projection in the cloud environment, this helps improve a resolution and definition of the control displayed on the client.

Because the control is drawn on the client locally, and that the user operates the control is to directly operate the control locally on the client, a link for triggering the user by the cloud-side application may be shortened, thereby helping reduce a delay of responding to a subsequent control operation.

For an embodiment in which the target control is the control associated with the to-be-transmitted screen of the cloud-side application, the server end 20 may further send the to-be-transmitted screen to the client 10 by using a streaming media technology. In an example, the cloud-side application on the server end 20 may locally display the to-be-transmitted screen. The server end 20 may perform compression processing on the to-be-transmitted screen, to obtain a compressed to-be-transmitted screen; and then send the compressed to-be-transmitted screen to the client 10 by using a streaming media technology. The client 10 may display the screen in a local display window.

The display window of the screen and the display window of the target control are independent windows. The display window of the screen is defined as a second window; and the display window of the target control above is defined as the first window. The first window and the second window are two independent windows. The first window may float over the second window. Because the display window of the screen and the display window of the control are independent of each other, performing an operation on the screen by the user does not affect display of the target control.

For example, the user may adjust a size of the screen, such as zoom in or zoom out the screen. The client 10 may obtain, in response to an operation event for the screen, operation behavior data associated with the operation event. The operation behavior data may include: an operation form of the operation event, a location of a window operated for the operation event, and the like. The operation form of the operation event may be understood as: a form in which the user operates the window, for example, single click on a right mouse button, double click on a left mouse button, keyboard input, or screen zooming. In an example, the client 10 may provide operation data to the server end 20. The server end 20 may adjust the screen based on the operation data, to obtain an adjusted to-be-transmitted screen. In another example, the server end 20 may transmit the adjusted to-be-transmitted screen to the client 10 by using the streaming media technology. The client 10 may display the adjusted screen. In a zooming and adjustment process of the screen, the display window of the target control of the client 10 does not change with zooming of the screen, to avoid that the target control moves outside the display window because of a zooming operation performed on the screen by the user, thereby reducing a probability or a risk that the user cannot operate the target control.

Because the target control is a human-machine interaction control, and the target control is usually configured to perform human-machine interaction with the user of the cloud-side application, when the user operates the control, a response operation associated with the control is triggered. In the related solution shown in FIG. 1, the user operates the control (corresponding to step 4 in FIG. 1), and the client 10 may obtain an operation event for the target control, and send the operation event to the server end 20 (corresponding to step 5 in FIG. 1). The operation event may include: operation behavior data for the target control. For descriptions about the operation behavior data, refer to related content in the foregoing embodiments. Details are not described herein again.

The server end 20 receives the operation event by using a streaming service, and transmits the operation event to the cloud-side application (corresponding to step 6 in FIG. 1). The cloud-side application on the server end 20 may obtain the operation behavior data for the target control in response to the operation event; and respond to the operation event for the target control based on the operation behavior data, to obtain response result data (corresponding to step 7, “Respond to the operation event” in FIG. 1), and transmit the response result data to the client 10 by using the streaming media technology and by using the streaming service in the server end 20 (corresponding to step 8 and step 9 in FIG. 1). The client 10 may output the response result data (corresponding to step 10 in FIG. 1).

For example, the target control is a start control corresponding to the cloud-side application. The operation behavior data may include: single click on a left mouse button and a location of the single click being on the target control, and the like. The server end 20 may start the cloud-side application based on the single click on the left mouse and the location of the single click being on the target control, and display a home page of the cloud-side application. In an example, the server end 20 may send the home page of the cloud-side application to the client 10 by using the streaming media technology. The client 10 may display the home page of the cloud-side application.

In the above related embodiment shown in FIG. 1, after the user performs an operation on the target control, the cloud-side application on the server end 20 can respond to the operation event only when the user sends the operation event to the cloud environment through a network, and the server end 20 sends a response result to the client 10 after responding, resulting in a large delay of responding to the operation on the target control.

To resolve the technical problem, as shown in FIG. 2, in this embodiment, the developer of the cloud-side application may further preconfigure response behavior data for the target control, and write the response behavior data for the target control into the cloud-side application. For specific implementations of this part, refer to related content in the foregoing embodiments. Details are not described herein again.

Based on the foregoing preconfigured response behavior data for the control, when sending the control creation instruction, the server end 20 may further obtain the preconfigured response behavior data for the target control (step 2 in FIG. 4); and control, based on the response behavior data, the client 10 to configure a response operation associated with an operation event of the target control.

In an implementation, the cloud-side application on the server end 20 may further encapsulate the UI configuration information of the target control and the response behavior data for the target control into the control creation instruction; and send the control creation instruction to the client 10 by using the network transmission protocol (corresponding to step 3 and step 4 in FIG. 4). In an example, as shown in step 3 and step 4 in FIG. 4, the cloud-side application may invoke the API to send the control creation instruction to the client 10 by using the network transmission protocol.

The client 10 may receive the control creation instruction, and obtain the UI configuration information of the target control and the response behavior data for the target control from the control creation instruction. Then, the client 10 may create the target control in the local window based on the UI configuration information; and configure the response operation for the target control based on the response behavior data (corresponding to step 5 in FIG. 4). In this way, when the target control is operated by the user (corresponding to step 6 in FIG. 4), the client 10 may perform, in response to the operation event for the target control, the response operation corresponding to the target control and output the response result (corresponding to step 7 in FIG. 4). In this way, the user can directly operate the local control of the client, and the client responds to the operation event for the control, so that a link for responding to the operation event for the control can be shortened, and response delay time in the cloud-side application scenario can be further reduced, thereby helping improve user experience.

In an implementation, as shown in steps 8 and 9 in FIG. 4, the client 10 may further send the operation event for the target control to the server end 20. The server end 20 may receive the operation event through the API, and transmit the operation event to the cloud-side application. The cloud-side application may execute a subsequent interaction logic and the like in response to the operation event (corresponding to step 10 in FIG. 4).

Certainly, in this embodiment, the response operation for the operation event for the target control may alternatively not be configured. In this embodiment, the client 10 may determine operation behavior data associated with an operation event in response to the operation event for the target control; and return the operation behavior data to the server end 20. The server end 20 may obtain the operation behavior data for the target control; and respond to the operation event for the target control based on the operation behavior data.

In addition to the foregoing system embodiments, an embodiment of this disclosure further provides a method of handling a control. The following exemplarily describes the method of handling a control according to this embodiment of the present disclosure.

FIG. 6 is a schematic flowchart of a method of handling a control according to an embodiment of this disclosure. The method is applicable to a server end of a cloud-side application. As shown in FIG. 6, the method of handling the control mainly includes the following steps. 601: Determine, from controls associated with the cloud-side application, a target control to be displayed on a client of the cloud-side application.

602: Obtain preconfigured UI configuration information of the target control.

603: Control, based on the UI configuration information, the client to create the target control in a first window.

In this embodiment, a developer of the cloud-side application preconfigures the control associated with the cloud-side application. For one control, the control has UI-associated information, such as a style, a display location, and content of the control. The style of the control may include: an icon, a shape, a color, a size, and the like of the control. Based on this, the developer of the cloud-side application may write, into the cloud-side application in advance, the control associated with the cloud-side application and the UI configuration information of the control. The UI configuration information refers to information for describing a UI layout of the control, and may include: a style, a display location, display content, and the like of the control.

Because the control is configured to perform human-machine interaction with a user of the cloud-side application, when the user triggers the control, a response operation associated with the control is triggered. The developer of the cloud-side application may further configure response behavior data for the control. At a development stage of the cloud-side application, the response behavior data for the control may be written into the cloud-side application. The response behavior data for the control is used for describing the response operation performed when the control is triggered.

For an embodiment of configuring a control for a page or a screen of the cloud-side application, the developer of the cloud-side application may further specify a target page, configure a control for the page, and configure UI configuration information of the control and response behavior data for the control. The developer of the cloud-side application may further write, into the cloud-side application in advance, an identifier of the selected target page, an identifier of the control configured for the page, the UI configuration information of the control, and the response behavior data for the control, and so on.

Based on the control and the UI configuration information of the control that are preconfigured in the foregoing embodiments, an embodiment of this disclosure provides a solution of drawing the control on the client of the cloud-side application in a cloud-side application scenario. Exemplary descriptions are provided below with reference to FIG. 6.

In FIG. 6, the cloud-side application runs on the server end. In step 601, the server end may determine, from the controls associated with the cloud-side application, the target control to be displayed on the client of the cloud-side application. In an example, the cloud-side application of the server end may determine, from the controls associated with the cloud-side application, the target control to be displayed on the client of the cloud-side application.

In some embodiments, the target control is a control, such as a start control, an exit control, or a stop control, configured to perform an operation on the cloud-side application. In this case, a control configured to represent the operation on the cloud-side application may be determined as the target control according to an identifier of the cloud-side application from the controls associated with the cloud-side application.

In some other embodiments, the target control may be a control associated with a screen of the cloud-side application, such as a control configured to perform an operation on the screen of the cloud-side application, or a control configured to perform operation guidance on the screen of the cloud-side application, In this embodiment, a to-be-transmitted screen may be determined according to a running process of the cloud-side application of the server end. The to-be-transmitted screen refers to a screen to be transmitted to the client, and is usually a screen to be displayed on the cloud-side application. In an example, a control associated with the to-be-transmitted screen may be determined as the target control according to an identifier of the to-be-transmitted screen from the controls associated with the cloud-side application.

In an implementation, a preconfigured control configured to perform operation guidance on the to-be-transmitted screen may be determined as the target control according to the identifier of the to-be-transmitted screen from the controls associated with the cloud-side application.

After the target control is determined, in step 602, the preconfigured UI configuration information of the target control may be obtained. In an example, the cloud-side application may determine, according to the running process of the cloud-side application, the target control corresponding to the running process, and obtain the UI configuration information of the target control.

In an implementation, in step 603, the client may be controlled, based on the UI configuration information, to create the target control in a display window (defined as the first window). The target control is a physical UI control. The target control may be displayed.

In this embodiment, to enable the server end to control the client to draw the control, an API related to control processing may be added in the server end, where the API is an interface for controlling the client. Based on the API, the cloud-side application of the server end may invoke the foregoing API to control the client to create the display window, so that the cloud-side application directly interacts with the client, thereby helping shorten a path from the cloud-side application to the user.

In an implementation, the UI configuration information of the target control may be encapsulated into a control creation instruction according to a network transmission protocol. The network transmission protocol may be a TCP, a HTTP, or the like. In an example, the control creation instruction may be sent to the client.

In an implementation, the cloud-side application may invoke the API in the foregoing embodiments, and send the control creation instruction to the client through the API.

The client may perform a method of handling a control shown in FIG. 7 to create the target control. The method of handling the control shown in FIG. 7 is applicable to the client of the cloud-side application. As shown in FIG. 7, the method mainly includes the following steps. 701: Receive a control creation instruction sent by a server end of the cloud-side application.

702: Obtain, from the control creation instruction, UI configuration information of a target control associated with the cloud-side application.

703: Create the target control in a first window based on the UI configuration information.

In FIG. 7, the client may receive the control creation instruction in step 701, and obtain the UI configuration information of the target control from the control creation instruction in step 702. In step 703, the target control may be created in the local first window based on the UI configuration information.

In this embodiment, the server end of the cloud-side application may determine, from the controls associated with the cloud-side application, the target control to be displayed on the client; obtain the preconfigured UI configuration information of the target control; and then control, based on the UI configuration information, the client to create the target control in the local window. In this way, the cloud-side application controls the client to create the control locally on the client, and the cloud-side application can directly interact with the client, thereby helping shorten a path from the cloud-side application to a user. Because the control is directly drawn on the client locally instead of being a projection in the cloud environment, this helps improve a resolution and definition of the control displayed on the client.

Because the control is drawn on the client locally, and that the user operates the control is to directly operate the control locally on the client, a link for triggering the user by the cloud-side application may be shortened, thereby helping reduce a delay of responding to a subsequent control operation.

For an embodiment in which the target control is a control associated with a to-be-transmitted screen of the cloud-side application, the server end may further send the to-be-transmitted screen to the client by using a streaming media technology. In an example, the cloud-side application on the server end may locally display the to-be-transmitted screen. The server end may perform compression processing on the to-be-transmitted screen by using a streaming service, to obtain a compressed to-be-transmitted screen; and then send the compressed to-be-transmitted screen to the client by using the streaming media technology. The client may display the screen in a local display window.

The display window of the screen and the display window of the target control are independent windows. The display window of the screen is defined as a second window; and the display window of the target control above is defined as the first window. The first window and the second window are two independent windows. The first window may float over the second window. Because the display window of the screen and the display window of the control are independent of each other, performing an operation on the screen by the user does not affect display of the target control.

For example, the user may adjust a size of the screen, such as zoom in or zoom out the screen. The client may obtain, in response to an operation event for the screen, operation behavior data associated with the operation event. In an example, the client may provide operation data to the server end. The server end may adjust the screen based on the operation data, to obtain an adjusted to-be-transmitted screen. In another example, the adjusted to-be-transmitted screen may be transmitted to the client by using the streaming media technology. The client may display the adjusted screen. In a zooming and adjustment process of the screen, the display window of the target control of the client does not change with zooming of the screen, to avoid that the target control moves outside the display window because of a zooming operation performed on the screen by the user, thereby reducing a probability or a risk that the user cannot operate the target control.

Because the target control is a human-machine interaction control, and the target control is usually configured to perform human-machine interaction with the user of the cloud-side application, when the user operates the control, a response operation associated with the control is triggered. In a related solution, the user operates the control, and the client may obtain an operation event for the target control, and send the operation event to the server end. The operation event may include: operation behavior data for the target control. For descriptions about the operation behavior data, refer to related content in the foregoing embodiments. Details are not described herein again.

The server end receives the operation event by using the streaming service, and transmits the operation event to the server end of the cloud-side application. The cloud-side application on the server end may obtain the operation behavior data for the target control in response to the operation event; and respond to the operation event for the target control based on the operation behavior data, to obtain response result data, and transmit the response result data to the client by using the streaming media technology and by using the streaming service in the server end. The client may output the response result data.

In a related embodiment, after the user performs an operation on the target control, the cloud-side application on the server end can respond to the operation event only when the user sends the operation event to the cloud environment through a network, and the server end sends a response result to the client after responding, resulting in a large delay of responding to the operation on the target control.

To resolve the technical problem, in this embodiment, a developer of the cloud-side application may further preconfigure response behavior data for the target control. For specific implementations of this part, refer to related content in the foregoing embodiments. Details are not described herein again.

Based on the foregoing preconfigured response behavior data for the control, when sending the control creation instruction, the server end may further obtain the preconfigured response behavior data for the target control; and control, based on the response behavior data, the client to configure a response operation associated with an operation event of the target control.

In an implementation, the server end may further encapsulate the UI configuration information of the target control and the response behavior data for the target control into the control creation instruction; and send the control creation instruction to the client by using the network transmission protocol. In an example, the cloud-side application may invoke the API to send the control creation instruction to the client by using the network transmission protocol.

The client may receive the control creation instruction, and obtain the UI configuration information of the target control and the response behavior data for the target control from the control creation instruction; then create the target control in the local window based on the UI configuration information; and configure the response operation for the target control based on the response behavior data. In this way, when the target control is operated by the user, the client may perform, in response to the operation event for the target control, the response operation corresponding to the target control and output the response result. The user can directly operate the local control of the client, and the client responds to the operation event for the control, so that a link for responding to the operation event for the control can be shortened, and response delay time in a cloud-side application scenario can be further reduced, thereby helping improve user experience.

In an implementation, the client may further send the operation event for the target control to the server end. The server end may receive the operation event through the API, and transmit the operation event to the cloud-side application. The cloud-side application may execute a subsequent interaction logic and the like in response to the operation event.

Certainly, in this embodiment, the response operation for the operation event for the target control may alternatively not be configured. In this embodiment, the client may determine operation behavior data associated with an operation event in response to the operation event for the target control; and return the operation behavior data to the server end. The server end may obtain the operation behavior data for the target control; and respond to the operation event for the target control based on the operation behavior data.

It should be noted that, user information (including, but not limited to, user equipment information, user personal information, and the like) and data (including, but not limited to, data for analysis, stored data, displayed data, and the like) involved in this disclosure are information and data that are authorized by the user or that are sufficiently authorized by all parties, related data needs to be collected, used, and processed by complying with related laws and regulations and standards of related countries and regions, and a corresponding operation entry is provided for the user to select to grant or deny authorization.

It should be noted that, execution entities of the steps of the methods provided in the foregoing embodiments may be a same device, or the methods may alternatively be performed by different devices. For example, execution entities of steps 601 and 602 may be a device A; for another example, an execution entity of step 601 may be a device A, and an execution entity of step 602 may be a device B; or the like.

In addition, some procedures described in the foregoing embodiments and accompanying drawings include a plurality of operations that appear in a specific sequence. However, it should be clearly understood that the operations may not be performed in the sequence in which the operations appear in this specification or may be performed in parallel, sequence numbers of the operations, such as 601 and 602, are merely used for distinguishing between different operations, and the sequence numbers do not indicate any execution sequence. Moreover, the procedures may include more or fewer operations, and the operations may be performed in sequence or in parallel.

In an implementation, an embodiment of this disclosure further provides a computer-readable storage medium storing computer instructions, where when the computer instructions are executed by one or more processors, the one or more processors are caused to perform the steps in the foregoing methods of handling the control.

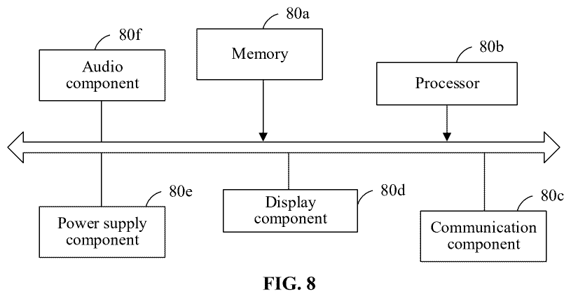

FIG. 8 is a schematic diagram of a structure of a computing device according to an embodiment of this disclosure. As shown in FIG. 8, the computing device includes: a memory 80a, a processor 80b, and a communication component 80c. The memory 80a is configured to store computer programs.

In some embodiments, the computing device may be implemented as a server end of a cloud-side application. The processor 80b is coupled to the memory 80a and the communication component 80c, and configured to execute the computer programs to: determine, from controls associated with the cloud-side application, a target control to be displayed on a client of the cloud-side application; obtain preconfigured user interface (UI) configuration information of the target control; and control, based on the UI configuration information through the communication component 80c, the client to create the target control in a first window.

In an implementation, when the processor 80b determines, from the controls associated with the cloud-side application, the target control to be displayed on the client of the cloud-side application, the processor 80b is specifically configured to: determine a to-be-transmitted screen of the cloud-side application according to a running process of the cloud-side application; and determine, according to an identifier of the to-be-transmitted screen from the controls associated with the cloud-side application, a control associated with the to-be-transmitted screen as the target control; or determine, according to an identifier of the cloud-side application from the controls associated with the cloud-side application, a control configured to represent an operation on the cloud-side application as the target control.

In an implementation, the processor 80b is further configured to: send the to-be-transmitted screen to the client by using a streaming media technology, so that the client displays the screen in a second window, where the first window floats over the second window.

In some embodiments, when the processor 80b controls, based on the UI configuration information of the target control, the client to create the target control in a first window, the processor 80b is specifically configured to: send a control creation instruction to the client through the cloud-side application, where the control creation instruction includes the UI configuration information, so that the client responds to the control creation instruction and creates the target control in the first window based on the UI configuration information.

In an implementation, the processor 80b is further configured to: obtain preconfigured response behavior data for the target control; and control, based on the response behavior data, the client to configure a response operation associated with an operation event for the target control, so that the client performs, in response to triggering of the target control, the response operation corresponding to the target control.

In some embodiments, the processor 80b is further configured to: receive, through the communication component 80c, operation behavior data returned by the client for the target control; and respond to an operation event for the target control based on the operation behavior data.

In some embodiments of this disclosure, the processor 80b may be implemented as the client of the cloud-side application. The processor 80b is coupled to the memory 80a and the communication component 80c, and configured to execute the computer programs to: receive, through the communication component 80c, a control creation instruction sent by a server end of the cloud-side application; obtain, from the control creation instruction, user interface (UI) configuration information of a target control associated with the cloud-side application; and create the target control in a first window based on the UI configuration information. The processor 80b is further configured to: display the target control through a display component 80d.

In an implementation, the processor 80b is further configured to: obtain response behavior data for the target control from the control creation instruction; configure a response operation for the target control based on the response behavior data; and perform the response operation in response to an operation event for the target control.

In an implementation, the processor 80b is further configured to: determine, in response to an operation event for the target control, operation behavior data associated with the operation event; and return the operation behavior data to the server end through the communication component 80c, so that the server end responds to an operation behavior of the target control based on the operation behavior data.

In an implementation, the processor 80b is further configured to: receive, through the communication component 80c, a screen sent by the server end by using a streaming media technology, and display the screen in a second window, where the first window floats over the second window.

In an implementation, as shown in FIG. 8, the computing device may further include: components such as a power supply component 80e and an audio component 80f. Only some components are schematically provided in FIG. 8, which does not mean that the computing device necessarily includes all the components shown in FIG. 8 or that the computing device can only include the components shown in FIG. 8.

In this embodiment, the server end of the cloud-side application may determine, from the controls associated with the cloud-side application, the target control to be displayed on the client; obtain the preconfigured UI configuration information of the target control; and then control, based on the UI configuration information, the client to create the target control in the local window. In this way, the cloud-side application controls the client to create the control locally on the client, and the cloud-side application can directly interact with the client, thereby helping shorten a path from the cloud-side application to a user.

In this embodiment of this disclosure, the memory is configured to store the computer programs, and may be configured to store various other data to support an operation on a device in which the memory is located. The processor may execute the computer programs stored in the memory, to implement a corresponding control logic. The memory may be implemented by any type of volatile or non-volatile storage device or a combination thereof, such as a static random access memory (Static Random Access Memory, SRAM), an electrically erasable programmable read-only memory (Electrically Erasable Programmable Read-Only Memory, EEPROM), an erasable programmable read-only memory (Electrical Programmable Read-Only Memory, EPROM), a programmable read-only memory (Programmable Read-Only Memory, PROM), a read-only memory (Read-Only Memory, ROM), a magnetic memory, a flash memory, a magnetic disk, or an optical disc.

In this embodiment of this disclosure, the processor may be any hardware processing device capable of executing a logic of the foregoing methods. In an example, the processor may be a central processing unit (Central Processing Unit, CPU), a graphics processing unit (Graphics Processing Unit, GPU), or a microcontroller unit (Microcontroller Unit, MCU); may be a programmable device such as a field programmable gate array (Field Programmable Gate Array, FPGA), a programmable array logic (Programmable Array Logic, PAL) device, a general array logic (General Array Logic, GAL) device, or a complex programmable logic device (Complex Programmable Logic Device, CPLD); may be an application-specific integrated circuit (Application Specific Integrated Circuit, ASIC) chip; or may be an advanced reduced instruction set computer (Reduced Instruction Set Computer, RISC) machine (Advanced RISC Machine, ARM), a system on chip (System on Chip, SoC), or the like, but is not limited thereto.

In this embodiment of this disclosure, the communication component is configured to facilitate wired or wireless communication between a device in which the communication component is located and other devices. The device in which the communication component is located may access a wireless network based on a communication standard, such as wireless fidelity (Wireless Fidelity, Wi-Fi), 2G or 3G, 4G, 5G, or a combination thereof. In an exemplary embodiment, the communication component receives a broadcast signal or broadcast-related information from an external broadcast management system through a broadcast channel. In an exemplary embodiment, the communication component may be further implemented based on a near-field communication (Near-Field Communication, NFC) technology, a radio-frequency identification (Radio-Frequency Identification, RFID) technology, an infrared data association (Infrared Data Association, IrDA) technology, an ultra-wideband (Ultra-Wideband, UWB) technology, a Bluetooth (Bluetooth, BT) technology, or other technologies.

In this embodiment of this disclosure, the display component may include a liquid crystal display (Liquid Crystal Display, LCD) and a touch panel (Touch Panel, TP). If the display component includes the touch panel, the display component may be implemented as a touchscreen, to receive an input signal by the user. The touch panel includes one or more touch sensors to sense a touch, a slide, and a gesture on the touch panel. The touch sensors may not only sense a boundary of a touch or slide operation, but also detect duration and pressure related to the touch or slide operation.

In this embodiment of this disclosure, the power supply component is configured to provide power to various components of a device in which the power supply component is located. The power supply component may include a power supply management system, one or more power supplies, and other components associated with generating, managing, and allocating power for the device in which the power supply component is located.

In this embodiment of this disclosure, the audio component may be configured to output and/or input an audio signal. For example, the audio component includes a microphone (Microphone, MIC). When a device in which the audio component is located is in an operation mode, such as a call mode, a recording mode, and a voice recognition mode, the microphone is configured to receive an external audio signal. The received audio signal may be further stored in the memory or sent through the communication component. In some embodiments, the audio component further includes a speaker, configured to output an audio signal. For example, for a device having a language interaction function, voice interaction and the like with the user may be implemented through the audio component.

It should be noted that, descriptions such as “first” and “second” in this specification are used to distinguish between different messages, devices, modules, and the like, do not indicate a sequence, and do not limit that “first” and “second” are of different types.

A person skilled in the art should understand that embodiments of this disclosure may be provided as a method, a system, or a computer program product. Therefore, this disclosure may use a form of hardware-only embodiments, software-only embodiments, or embodiments combining software and hardware. In addition, this disclosure may use a form of a computer program product implemented on one or more computer-usable storage media (including, but not limited to, a magnetic disk memory, a compact disc read-only memory (Compact Disc Read-Only Memory, CD-ROM), an optical memory, and the like) including computer-usable program codes.

This disclosure are described with reference to the flowcharts and/or block diagrams of the method, the device (or system), and the computer program product according to embodiments of this disclosure. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a dedicated computer, an embedded processor, or processors of other programmable data processing devices to generate a machine, so that an apparatus configured to implement functions specified in one or more procedures in the flowcharts and/or one or more blocks in the block diagrams is generated by using instructions executed by the computer or the processors of other programmable data processing devices.

These computer program instructions may alternatively be stored in a computer-readable memory that can instruct a computer or other programmable data processing devices to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may alternatively be loaded onto a computer or other programmable data processing devices, so that a series of operations and steps are performed on the computer or the other programmable devices, thereby generating computer-implemented processing. Therefore, the instructions executed on the computer or the other programmable devices provide steps for implementing a specific function in one or more procedures in the flowcharts and/or in one or more blocks in the block diagrams.

In a typical configuration, the computing device includes one or more processors (for example, CPUs), an input/output interface, a network interface, and an internal storage.

The internal storage may include a non-permanent memory, a random access memory (Random Access Memory, RAM), a non-volatile memory, such as a read-only memory (Read-Only Memory, ROM) or a flash memory (Flash RAM), and/or the like in a computer-readable medium. The internal storage is an example of the computer-readable medium.

A storage medium of the computer is a readable storage medium, or may also be referred to as a readable medium. The readable storage medium includes permanent and non-permanent and removable and non-removable media that can store information by using any method or technology. The information may be a computer-readable instruction, a data structure, a program module, or other data. Examples of the storage medium of the computer include, but are not limited to, a phase-change memory (Phase-Change Memory, PRAM), a static random access memory (Static Random Access Memory, SRAM), a dynamic random access memory (Dynamic Random Access Memory, DRAM), another type of random access memory (RAM), a read-only memory (ROM), an electrically erasable programmable read-only memory (Electrically Erasable Programmable Read-Only Memory, EEPROM), a flash memory or other memory technologies, a compact disc read-only memory (CD-ROM), a digital video disc (Digital Video Disc, DVD) or other optical storages, a magnetic cassette tape, a magnetic disk storage or other magnetic storage devices or any other non-transmission medium that can be used to store information accessible by the computing device. As defined in this specification, the computer-readable medium does not include transitory computer-readable media (Transitory Media), such as a modulated data signal and a carrier wave.

It should be further noted that the terms “include” “comprise” and any variation thereof are intended to cover a non-exclusive inclusion. Therefore, in the context of a process, a method, a product, or a device that includes a series of elements, the process, method, product, or device not only includes such elements, but also includes other elements not specified expressly, or may include inherent elements of the process, method, product, or device. Without more limitations, an element defined by the sentence “include a/an . . . ” does not exclude that there are still other same elements in the process, the method, the product, or the device that includes the foregoing elements.

The foregoing content is merely embodiments of this disclosure, and is not intended to limit this disclosure. For a person skilled in the art, various modifications and variations may be made to this disclosure. Any modification, equivalent replacement, or improvement made without departing from the spirit and principle of this disclosure shall fall within the scope of the claims of this disclosure.

1. A method of handling a control, applicable to a server end of a cloud-side application, wherein the method comprises:
determining, from controls associated with the cloud-side application, a target control to be displayed on a client of the cloud-side application;
obtaining preconfigured user interface (UI) configuration information of the target control; and
controlling, based on the UI configuration information, the client to create the target control in a first window.

2. The method according to claim 1, wherein the determining, from the controls associated with the cloud-side application, the target control to be displayed on the client of the cloud-side application comprises:
determining a to-be-transmitted screen of the cloud-side application according to a running process of the cloud-side application; and determining, according to an identifier of the to-be-transmitted screen from the controls associated with the cloud-side application, a control associated with the to-be-transmitted screen as the target control;
or
determining, according to an identifier of the cloud-side application from the controls associated with the cloud-side application, a control configured to represent an operation on the cloud-side application as the target control.

3. The method according to claim 2, wherein the method further comprises:
sending the to-be-transmitted screen to the client by using a streaming media technology, so that the client displays the screen in a second window, wherein the first window floats over the second window.

4. The method according to claim 1, wherein the controlling, based on the UI configuration information, the client to create the target control in the first window comprises:
sending a control creation instruction to the client through the cloud-side application, wherein the control creation instruction comprises the UI configuration information, so that the client responds to the control creation instruction and creates the target control in the first window based on the UI configuration information.

5. The method according to claim 1, wherein the method further comprises:
obtaining preconfigured response behavior data for the target control; and
controlling, based on the response behavior data, the client to configure a response operation associated with an operation event for the target control, so that the client performs, in response to triggering of the target control, the response operation corresponding to the target control.

6. The method according to claim 1, wherein the method further comprises:
receiving operation behavior data returned by the client for the target control; and
responding to an operation event for the target control based on the operation behavior data.

7. A method of handling a control, applicable to a client of a cloud-side application, wherein the method comprises:
receiving a control creation instruction sent by a server end of the cloud-side application;
obtaining, from the control creation instruction, user interface (UI) configuration information of a target control associated with the cloud-side application; and
creating the target control in a first window based on the UI configuration information.

8. The method according to claim 7, wherein the method further comprises:
obtaining response behavior data for the target control from the control creation instruction;
configuring a response operation for the target control based on the response behavior data; and
performing the response operation in response to an operation event for the target control.

9. The method according to claim 7, wherein the method further comprises:
determining, in response to an operation event for the target control, operation behavior data associated with the operation event; and
returning the operation behavior data to the server end, so that the server end responds to an operation behavior of the target control based on the operation behavior data.

10. The method according to claim 7, wherein the method further comprises:
receiving a screen sent by the server end by using a streaming media technology, and displaying the screen in a second window, wherein the first window floats over the second window.

11. A data processing system, comprising: a client of a cloud-side application, and a server end of the cloud-side application, wherein
the client is configured to:
receive a control creation instruction sent by the server end of the cloud-side application;
obtain, from the control creation instruction, user interface (UI) configuration information of a target control associated with the cloud-side application; and
create the target control in a first window based on the UI configuration information; and
the server end is configured to:
determine, from controls associated with the cloud-side application, the target control to be displayed on the client of the cloud-side application;
obtain preconfigured UI configuration information of the target control; and
control, based on the UI configuration information, the client to create the target control in the first window.

12. A computing device, comprising: a memory, a processor, and a communication component, wherein the memory is configured to store computer programs; and
the processor is coupled to the memory and the communication component, and configured to execute the computer programs to perform the steps in the method performed by the client in claim 11, or the steps in the method performed by the server end in claim 11.

13. A non-transitory computer-readable storage medium storing computer instructions, wherein when the computer instructions are executed by one or more processors, the one or more processors are caused to perform the steps in the method performed by the client in claim 11, or the steps in the method performed by the server end in claim 11.

14. The system according to claim 11, wherein when the server end determines, from the controls associated with the cloud-side application, the target control to be displayed on the client of the cloud-side application, the server end is configured to:
determine a to-be-transmitted screen of the cloud-side application according to a running process of the cloud-side application; and determine, according to an identifier of the to-be-transmitted screen from the controls associated with the cloud-side application, a control associated with the to-be-transmitted screen as the target control;
or
determine, according to an identifier of the cloud-side application from the controls associated with the cloud-side application, a control configured to represent an operation on the cloud-side application as the target control.

15. The system according to claim 14, wherein
the server end is further configured to send the to-be-transmitted screen to the client by using a streaming media technology, so that the client displays the screen in a second window;
the client is further configured to: receive the screen sent by the server end by using a streaming media technology, and display the screen in the second window;
wherein the first window floats over the second window.

16. The system according to claim 11, wherein when the server end controls, based on the UI configuration information, the client to create the target control in the first window, the server end is further configured to:
send the control creation instruction to the client through the cloud-side application, wherein the control creation instruction comprises the UI configuration information, so that the client responds to the control creation instruction and creates the target control in the first window based on the UI configuration information.

17. The system according to claim 11, wherein the server end is further configured to:
obtain preconfigured response behavior data for the target control; and
controls, based on the response behavior data, the client to configure a response operation associated with an operation event for the target control, so that the client performs, in response to triggering of the target control, the response operation corresponding to the target control.

18. The system according to claim 11, wherein the server end is further configured to:
receive operation behavior data returned by the client for the target control; and
respond to an operation event for the target control based on the operation behavior data.

19. The system according to claim 11, wherein the client is further configured to:
obtain response behavior data for the target control from the control creation instruction;
configure a response operation for the target control based on the response behavior data; and
perform the response operation in response to an operation event for the target control.

20. The system according to claim 11, wherein the client is further configured to:
determine, in response to an operation event for the target control, operation behavior data associated with the operation event; and
return the operation behavior data to the server end, so that the server end responds to an operation behavior of the target control based on the operation behavior data.
